(19) United States
(12) Patent Application Publication
(10) Pub. No.: US 2015/0253903 A1
(43) Pub. Date: Sep. 10, 2015

(54) TOUCH WINDOW AND TOUCH DEVICE INCLUDING THE SAME

(71) Applicant: LG INNOTEK CO., LTD., Seoul (KR)

(72) Inventors: Jae Hong LEE, Seoul (KR); Jun Sik SHIN, Seoul (KR); Joon Hyuk YANG, Seoul (KR); Chan Kyu KOO, Seoul (KR); Jong Sun KIM, Seoul (KR)

(21) Appl. No.: 14/636,290

(22) Filed: Mar. 3, 2015

(30) Foreign Application Priority Data
Mar. 6, 2014 (KR) 10-2014-0026736

(51) Int. Cl. G06F 3/044

(52) U.S. Cl. CPC G06F 3/044

(57) ABSTRACT

A touch window includes a substrate, a sensing electrode on the substrate, a wire electrically connected with the sensing electrode, and a pad part provided at one end of the wire and connected with a printed circuit board. The pad part has surface roughness (Ra) different from surface roughness (Ra) of the wire. A touch device includes a touch window, and a driving part on the touch widow. The touch window includes a substrate, a sensing electrode on the substrate, a wire electrically connected with the sensing electrode, and a pad part provided at one end of the wire and connected with a printed circuit board. The pad part has surface roughness (Ra) different from surface roughness (Ra) of the wire.

### CROSS-REFERENCE TO RELATED APPLICATION

This application claims priority under 35 U.S.C. §119 to Korean Application No. 10-2014-0026736 filed on Mar. 6, 2014, whose entire disclosure is incorporated herein by reference.

### BACKGROUND

1. Field

The disclosure relates to a touch window and a touch device including the same.

2. Background

Recently, a touch panel, which performs an input function through the touch of an image displayed on a touch device by an input such as a stylus pen or a finger has been applied to various electronic appliances. The touch panel may be representatively classified into a resistive touch panel and a capacitive touch panel. In the resistive touch panel, the position of the touch point is detected by detecting the variation of resistance according to the connection between electrodes when pressure is applied to the input device. In the capacitive touch panel, the position of the touch point is detected by detecting the variation of capacitance between electrodes when a finger of the user is touched on the capacitive touch panel. When taking into consideration the convenience of a fabrication scheme and a sensing power, the capacitive touch panel has been spotlighted in a smaller model touch panel recently.

Meanwhile, the touch panel includes a printed circuit board to drive an electrical signal. When the printed circuit board is bonded to a pad part of a wire, the bonding process is performed using a conductive paste.

### BRIEF DESCRIPTION OF THE DRAWINGS

The embodiments will be described in detail with reference to the following drawings in which like reference numerals refer to like elements wherein:

FIG. 1 is a perspective view showing a touch window according to one embodiment.

FIG. 2 is a plan view showing the touch window according to one embodiment.

FIG. 3 is an enlarged view showing a part A of FIG. 2.

FIG. 4 is a sectional view taken along line I-I′ of FIG. 3.

FIG. 5 is an enlarged view showing a touch window according to another embodiment.

FIG. 6 is a sectional view taken along line II-II′ of FIG. 5.

FIG. 7 is an enlarged view showing a touch window according to another embodiment.

FIG. 8 is a sectional view taken along line III-III′ of FIG. 7.

FIG. 9 is a sectional view showing a touch window according to another embodiment.

FIG. 10 is a sectional view showing a touch window according to another embodiment.

FIG. 11 is an enlarged view showing a touch window according to another embodiment.

FIG. 12 is a sectional view taken along line IV-IV′ of FIG. 11.

FIG. 13 is an enlarged view showing a touch window according to another embodiment.

FIG. 14 is a sectional view showing a touch window according to another embodiment.

FIG. 15 is a sectional view showing a touch window according to another embodiment.

FIGS. 16 to 19 are views showing a touch device formed by coupling the touch window according to the embodiment with the display panel.

FIGS. 20 to 23 are views showing one example of a touch device employing the touch window according to the embodiment.

### DETAILED DESCRIPTION

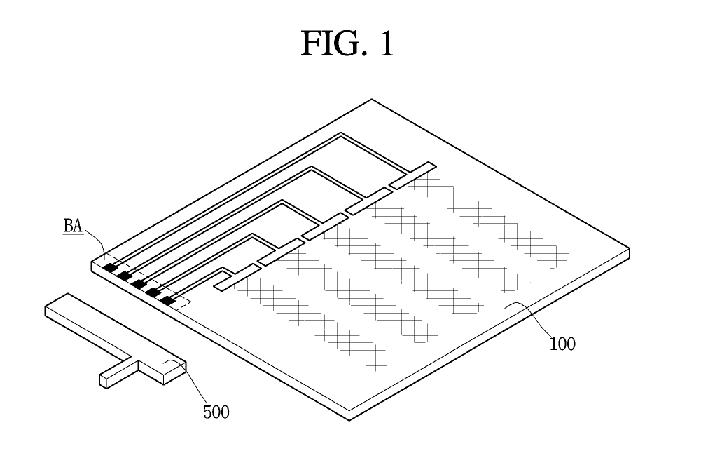

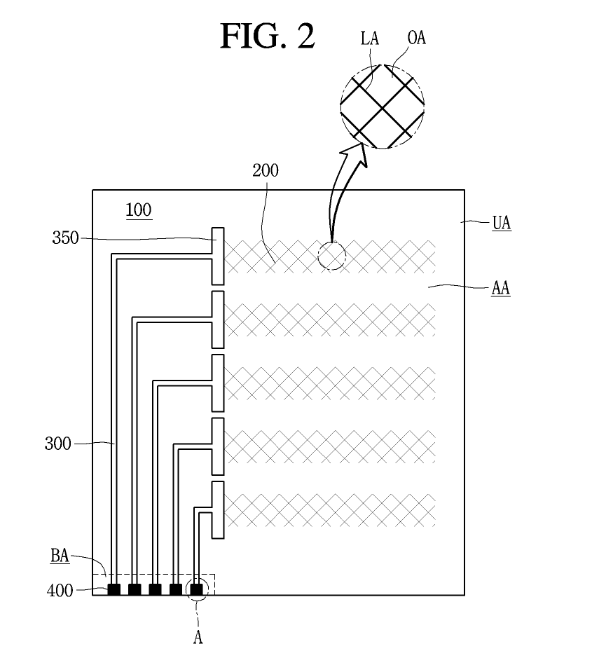

A touch window according to the embodiment will be described below with reference to FIGS. 1 to 3. Referring to FIGS. 1 and 2, the touch window according to the embodiment may include a substrate 100, a sensing electrode 200, a wire 300, and a pad part 400.

The substrate 100 may be rigid or flexible. For example, the substrate 100 may include a glass substrate or a plastic substrate. In detail, the substrate 100 may include chemically tempered/semi-tempered glass, such as soda lime glass or aluminosilicate glass, reinforced/flexible plastic, such as polyimide (PI), polyethylene terephthalate (PET), propylene glycol (PPG), or poly carbonate (PC), or sapphire.

In addition, the substrate 100 may include an optically isotropic film. For example, the substrate 100 may include cyclic olefin copolymer (COO), cyclic olefin polymer (COP), optically isotropic polycarbonate (PC), or optically isotropic polymethyl methacrylate (PMMA).

The sapphire 100 has superior electric characteristics, such as permittivity, so that a touch response speed may be greatly increased and a space touch such as hovering may be easily implemented. In addition, since the sapphire has high surface hardness, the sapphire is applicable to a cover substrate. The hovering refers to a technique of recognizing coordinates even at a slight distance from a display.

In addition, the substrate 100 is bendable with a partially curved surface. In other words, the substrate 100 is bendable while a portion of the substrate 100 has a flat surface and another portion of the substrate 100 has a curved surface. In detail, an end portion of the substrate 100 may be bent with a curved surface or may be curved or bent with a surface having a random curvature.

In addition, the substrate 100 may include a flexible substrate having a flexible property. In addition, the substrate 100 may include a curved substrate or a bended substrate. In other words, the touch window including the substrate 100 may be formed with a flexible, curving, or bending characteristic. Accordingly, the touch window according to the embodiment can be easily carried by a user and may be modified to touch windows having various designs.

The substrate 100 may be provided thereon with the sensing electrode 200, the wire 300, the pad part 400, and a printed circuit board 500. In other words, the substrate 100 may be a support substrate.

The substrate 100 may include a cover substrate. In other words, the sensing electrode 200, the wire 300, the pad part 400, and the printed circuit board 500 may be supported by the cover substrate. In addition, an additional cover substrate may be additionally provided on the substrate 100. In other words, the sensing electrode 200, the wire 300, and the printed circuit board 500 may be supported by the substrate 100, and the substrate 100 and the cover substrate may be combined (bonded to) with each other.

The substrate 100 may have an active region AA and an unactive region UA defined therein. An image may be displayed in the active region AA, and the image may not be displayed in the unactive region UA provided at a peripheral portion of the active region AA.

In addition, the position of an input device (e.g. finger) can be detected in at least one of the active region AA and the unactive region UA. If the input device, such as a finger, touches the touch window, the variation of capacitance occurs in the touched part by the input device, and the touched part subject to the variation of the capacitance may be detected as a touch point.

An outer dummy layer is formed in the unactive region UA of the substrate 100. The outer dummy layer may be coated with a material having a predetermined color so that the wire 300 provided in the unactive region UA and the printed circuit board 500 connecting the wire 300 to an external circuit cannot be viewed from the outside.

The outer dummy layer may have a color suitable for a desired outer appearance thereof. For example, the outer dummy layer includes black or white pigments to represent black or white. In addition, the outer dummy layer may represent various colors such as red or blue using various color films.

In addition, a desired logo may be formed in the outer dummy layer through various schemes. The outer dummy layer may be formed through deposition, print, and wet coating schemes. The outer dummy layer may be provided in at least one layer. For example, the outer dummy layer may be provided in one layer or provided in at least two layers having widths different from each other. Thereafter, the sensing electrode 200 may be formed in the active region AA to detect the input device.

Although FIG. 2 shows that the sensing electrode 200 has a bar shape, the embodiment is not limited thereto. Accordingly, the sensing electrode 200 may have various shapes sufficient to detect the touch by the input device such as a finger.

Although FIG. 2 shows that the sensing electrode 200 extends in one direction, the embodiment is not limited thereto. Therefore, the sensing electrode 200 may include two types of a sensing electrode extending in one direction and a sensing electrode extending in another direction crossing the one direction.

If the input such as a finger touches the touch window, the variation of capacitance occurs in the touched part by the input device, and the touched part subject to the variation of the capacitance may be detected as a touch point. The sensing electrode 200 may include a transparent conductive material that allows electricity to flow therethrough without interrupting transmission of light. For example, the sensing electrode 200 may include a metallic oxide such as an indium tin oxide (ITO), an indium zinc oxide (IZO), a copper oxide, a tin oxide, a zinc oxide, or a titanium oxide.

In addition, the sensing electrode 200 may include a nanowire, a photosensitive nanowire film, carbon nanotube (CNT), graphene, conductive polymer, or the mixture thereof. In addition, the sensing electrode 200 may include various metals. For example, the sensing electrode 200 may include at least one of chromium (Cr), nickel (Ni), copper (Cu), aluminum (Al), silver (Ag), molybdenum (Mo), gold (Au), titanium (Ti), and the alloy thereof.

In addition, the sensing electrode 200 may include a conductive pattern. For example, the sensing electrode 200 may be provided in a mesh shape. In this case, the mesh shape may be randomly formed to prevent a moiré phenomenon. The moiré phenomenon occurs when periodical stripes overlap with each other. Since adjacent stripes overlap with each other, a thickness of a stripe is thickened so that the stripe is spotlighted as compared with other stripes. In order to prevent the moiré phenomenon, the conductive pattern shape may be variously formed.

In detail, the sensing electrode 200 has a mesh shape, and may include conductive pattern line parts LA by a plurality of sub-electrodes crossing each other and a conductive pattern opening art OA between the conductive pattern line parts LA. The line width of each conductive pattern line part LA may be in the range of about 0.1 μm to about 10 μm. The conductive pattern line part LA having the line width of about 0.1 μm or less may not be formed due to the characteristic of the manufacturing process or may cause the short between mesh lines. If the line width exceeds about 10 μm, the electrode pattern is viewed from the outside so that the visibility may be degraded. Preferably, the line width of the conductive pattern line part LA may be in the range of about 0.5 μm to about 7 μm. More preferably, the line width of the mesh line may be in the range of about 1 μm to about 3.5 μm.

Meanwhile, as shown in FIG. 2, the conductive pattern opening part OA may have various shapes. For example, the conductive pattern opening part OA may have various shapes such as a polygonal shape including a rectangular shape, a diamond shape, a pentagonal shape, or a hexagonal shape, or a circular shape. In addition, the conductive pattern opening part OA may have a regular shape or a random shape.

As the sensing electrode 200 has the mesh shape, the pattern of the sensing electrode 200 may not be viewed in the active region AA. In other word, even if the sensing electrode 200 includes metal, the pattern of the sensing electrode 200 may not be viewed. In addition, even if the sensing electrode 200 is applied to a large touch window, the resistance of the touch window may be lowered. Further, the sensing electrode 200 includes a conductive pattern to improve printing quality, so that the high-quality touch window can be ensured.

Meanwhile, the embodiment is not limited thereto, but the sensing electrode 200 may include patterns having various shapes different from the mesh shape.

Hereinafter, a method of forming the sensing electrode 200 having the mesh shape will be described.

First, for a sensing electrode according to the embodiment, a metallic layer is formed on the entire surface of a substrate and etched in a mesh shape, so that the mesh-shaped electrode can be formed. For example, after depositing metal such as copper (Cu) on the entire surface of the substrate 100 including polyether terephthalate, the Cu layer is etched to form a Cu mesh electrode having an embossed mesh shape.

According to another embodiment, for the sensing electrode according to the embodiment, after forming a resin layer (or intermediate layer) including a photo-curing resin (UV resin) or a thermosetting resin on the substrate 100, an intaglio pattern P having the mesh shape may be formed on the resin layer and a conductive material may be filled in the intaglio pattern P. In this case, the intaglio pattern of the resin layer may be formed by performing an imprinting process using a mold having an embossed pattern.

The conductive material may include a metallic paste including at least one of Cr, Ni, Cu, Al, Ag, Mo, and the alloy thereof. Accordingly, the metallic paste is filled in the meshed-shape intaglio pattern and cured, or plated to form an intaglio metallic mesh electrode having the mesh shape.

In addition, in the sensing electrode according to the embodiment, after forming a resin layer (or intermediate layer) including a photo-curing resin (UV resin) or a thermosetting resin on the substrate 100, the 1′st-pattern and the 2′nd-pattern having an embossed shape or an intaglio pattern are formed on the resin layer. Then, at least one of metallic layers including Cr, Ni, Cu, Al, Ag, Mo and the alloy thereof may be deposited on the resin layer through the sputtering process.

The 1′st-pattern may have nano scale width (ex. 100-300 nm). And, the 2′nd-pattern may have micro scale width (ex. 1˜10 um). The 1′st-pattern and the 2′nd-pattern having the embossed shapes may be formed using a mold having the intaglio pattern. The intaglio pattern may be formed by performing the imprinting process having the embossed pattern.

Thereafter, by etching the metallic layer formed on the 1′st-pattern and the 2′nd-pattern, only the metallic layer is removed from the 1′st-pattern, and only the metallic layer formed on the 2′nd-pattern remains, so that the metallic electrode having the mesh shape can be formed.

In this case, when the metallic layer is etched, the difference in the etching rate between the 1′st-pattern and the 2′nd-pattern may be made depending on the difference between the contact areas of the metallic layer with the 1′st-pattern and the 2′nd-pattern. In other words, since the contact area of the metallic layer with the 2′nd-pattern is wider than the contact area of the metallic layer with the 1′st-pattern, the electrode material formed on the 2′nd-pattern is less etched. In addition, as the etching is performed at the same etching rate, the metallic layer formed on the 2′nd-pattern remains, and the metallic layer formed on the 1′st-pattern is etched and removed. Accordingly, the metallic electrode having the 2′nd-pattern and the embossed mesh shape or the intaglio mesh shape can be formed.

Meanwhile, the wire 300 may be formed in the unactive region UA for the electrical connection of the sensing electrode 200. One end of the wire 300 may be connected with the sensing electrode 200.

The wire 300 may include a conductive material. For example, the wire 300 may include a material the same as or similar to that of the sensing electrode 200. In addition, the wire 300 may be formed in the mesh shape.

A wire pad 350 may be interposed between the sensing electrode 200 and the wire 300. The wire pad 350 may electrically connect the sensing electrode 200 with the wire 300. The wire pad 350 may include a material the same as or similar to that of the wire 300. For example, the wire pad 350 may be provided at one end of the sensing electrode 200, and one end of the wire 300 is connected with the wire pad 350, so that the wire 300 can be electrically connected with the sensing electrode 200.

A pad art 400 may be provided at one end of the wire 300. The wire 300 may be formed integrally with the pad part 400. For example, the wire pad 350 may be provided at one end of the wire 300, and the pad part 400 may be integrally formed at an opposite end of the wire 300.

The pad part 400 may be connected with the printed circuit board 500. In other words, the wire 300 may be electrically connected with the printed circuit board 500 through the pad part 400, and may be electrically connected with the sensing electrode 200 through the wire pad 350. In other words, the printed circuit board 500 may be electrically connected with the sensing electrode 200 through the wire 300.

In detail, although not shown in FIG. 2, a connector may be positioned on any one surface of the printed circuit board 500, and the pad part 400 may be connected with the connector. The pad part 400 may be formed in the size corresponding to the connector so that the pad part 400 may be connected with the connector. The printed circuit board 500 may employ various types of printed circuit boards. For example, a flexible printed circuit board (FPCB) may be employed.

Meanwhile, a bonding part BA for the arrangement of the printed circuit board 500 may be defined in the substrate 100. The pad part 400 may be provided in the bonding part BA. The printed circuit board 500 may be arranged on the bonding part BA so that the printed circuit board 500 may be bonded to the bonding part BA.

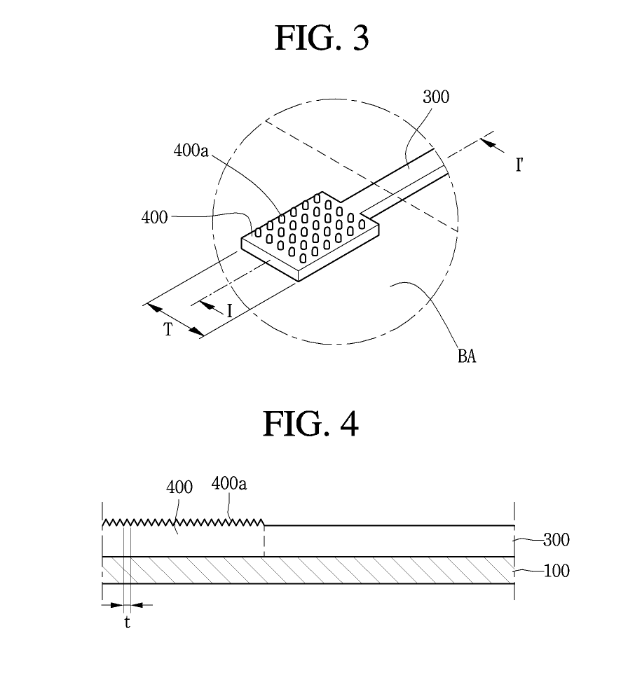

Meanwhile, referring to FIGS. 3 and 4, the surface roughness(Ra) of the pad part 400 may be different from the surface roughness(Ra) of the wire 300. In detail, the surface roughness(Ra) of the pad part 400 may be greater than the surface roughness(Ra) of the wire 300. The roughness(Ra) of the top surface of the pad part 400 may be greater than the roughness(Ra) of the top surface of the wire 300.

Meanwhile, the top surface of the wire 300 may have a pattern different from that of the top surface of the pad part 400. The top surface of the pad part 400 may have regular or irregular unevenness shapes. For example, the pad part 400 may include a fine-pattern 400a. The fine pattern 400a may have a protrusion shape. In this case, a line width t of the fine pattern 400a may be narrower than ½ of a line width T of the pad part 400. Accordingly, the contact area of the pad part 400 with the printed circuit board 500 can be increased. Accordingly, the bonding characteristic between the pad part 400 and the printed circuit board 500 can be improved. Accordingly, an input signal can be exactly transmitted to the printed circuit board 500, and the reliability of the touch window can be improved.

In addition, an additional bonding material may be omitted or reduced between the pad part 400 and the printed circuit board 500. Accordingly, the process can be simplified, and the cost can be saved.

Meanwhile, although a drawing shows that the difference is not greatly made in the thickness between the wire 300 and the substrate 100, the difference in the thickness between the wire 300 and the substrate 100 may be significantly made in an actual product.

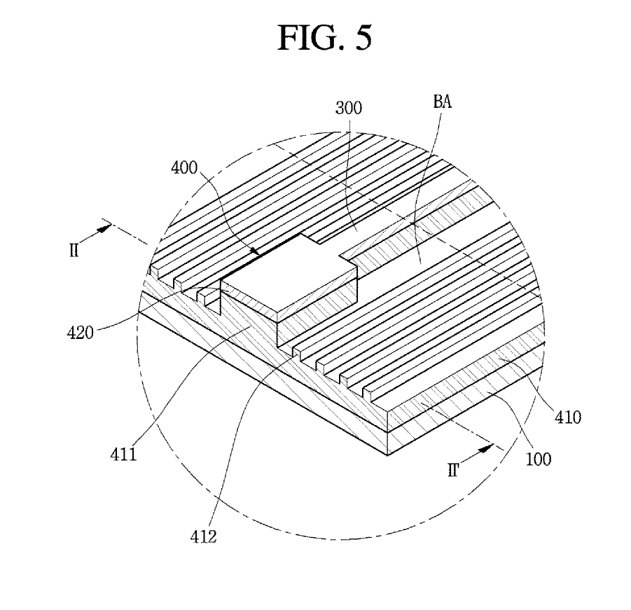

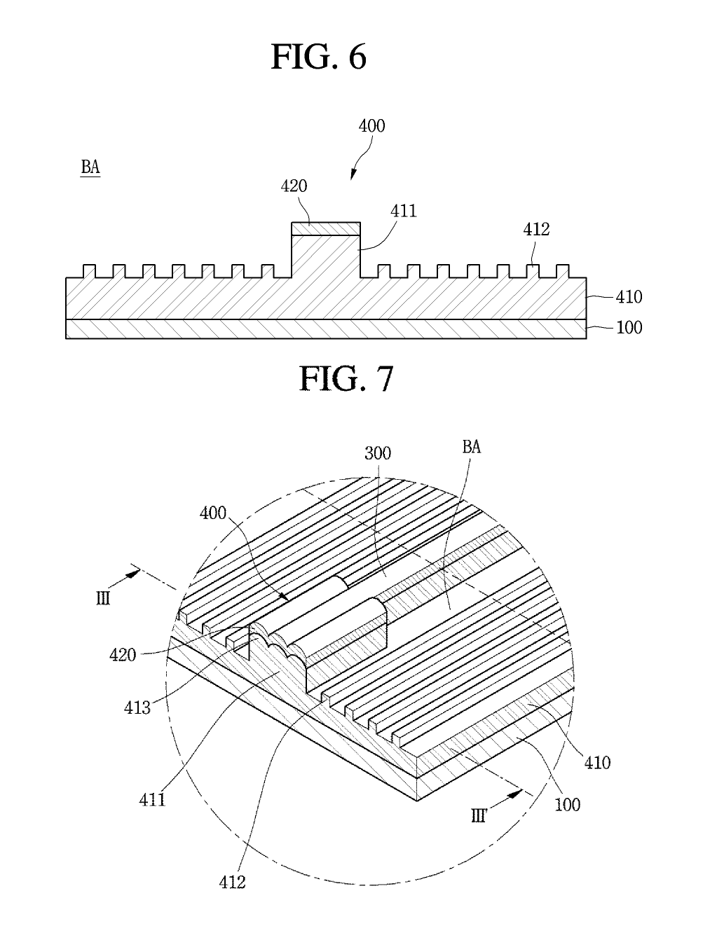

Meanwhile, a touch window according to another embodiment will be described with reference to FIGS. 5 and 6. In the following description, the details of the structures and the components the same as or similar to the above-described structures and components will be omitted for the clear and concise explanation.

Referring to FIGS. 5 and 6, a bonding part BA of the touch window according to another embodiment may include a first pattern 411, a second pattern 412, and a conductive layer 420. The first pattern 411 may be formed on a resin layer 410. The second pattern 412 may be arranged on the resin layer 410.

For example, the first and second patterns 411 and 412 having an embossed mesh shape or an intaglio mesh shape may be formed on the resin layer 410. In this case, the embossed mesh shape may be formed by imprinting a mold having the intaglio mesh shape, and the intaglio mesh shape may be formed by imprinting a mold having the embossed mesh shape.

The second pattern 412 may be provided adjacent to the first pattern 411. The line width of the second pattern 412 may be narrower than the line width of the first pattern 411. Accordingly, an etched area may be varied depending on the difference between the structures of the first and second patterns 411 and 412, and the difference between the contact areas of the first and second patterns 411 and 412 with an electrode material when the electrode material is deposited and etched on the first and second patterns 411 and 412. For example, at least one of Cr, Ni, Cu, Al, Ag, Mo, and the alloy thereof may be deposited through the sputtering process. Thereafter, by etching the electrode material formed on the first and second patterns 411 and 412, only the electrode material is removed from the second pattern 412, and only the electrode material formed on the first pattern 411 remains, so that the metallic electrode having the mesh shape can be formed. In other words, since the contact area of the first pattern 411 with the electrode material is greater than the contact area of the second pattern 412 with the electrode material, the electrode material formed on the first pattern 411 is less etched. In other words, the electrode material formed on the first pattern 411 remains and the electrode material formed on the second pattern 412 is etched and removed as the etching is performed at the same etching rate. Accordingly, the electrode layer 222 may be formed only on the first pattern 411. The pad part 400 may be formed through the above scheme.

The first and second patterns 411 and 412 may include resin, such as photo-curing resin (UV resin) or a thermosetting resin, or polymer. The conductive layer 420 is provided on the first pattern 411. The first pattern 411 and the conductive layer 420 may constitute the pad part 400.

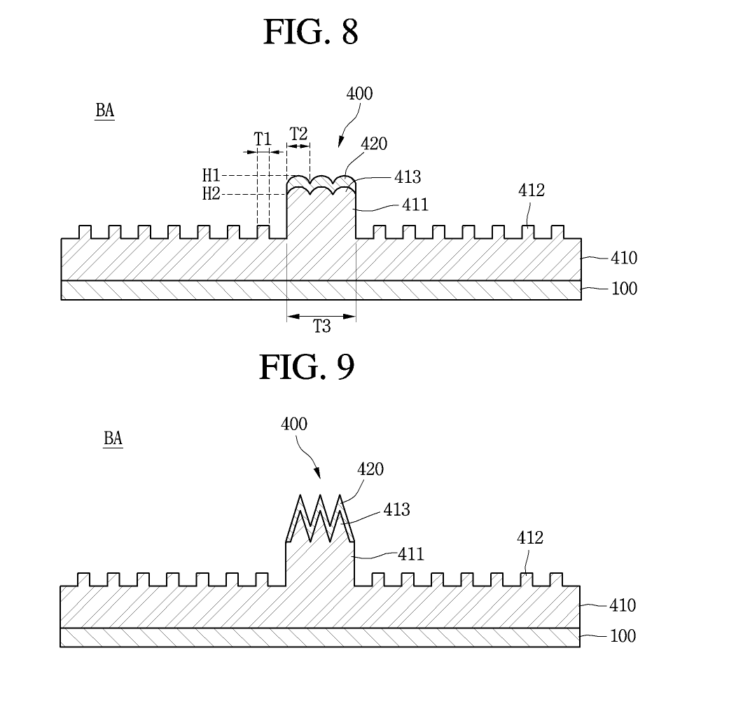

The first and second patterns 411 and 412 may be formed through the imprinting process. Accordingly, the pad part 400 may be formed through a simple process. Meanwhile, referring to FIGS. 7 and 8, the touch window according to another embodiment may include a third pattern 413 provided on the first pattern 411. The section of the third pattern 413 may have an unevenness shape. For example, the third pattern 413 may have a semi-circular shape.

A line width T2 of the third pattern 413 may be wider than a line width T1 of the second pattern 412. The line width T2 of the third pattern 413 may be less than the line width T3 of the pad part 400. In this case, the line width T2 of the third pattern 413 may be less than ½ of the line width T3 of the pad part 400.

The conductive layer 420 may be provided on the third pattern 413. The conductive layer 420 may include parts having heights H1 and H2 different from each other. In other words, since the conductive layer 420 is formed according to the shape of the third pattern 413, the conductive layer 420 may include parts having low or high heights H1 and H2.

Meanwhile, referring to FIG. 9, the touch window according to another embodiment may include the third pattern 413 provided on the first pattern 411, and the sectional surface of the third pattern 413 may have a triangular shape. The conductive layer 420 may be formed on the third pattern 413.

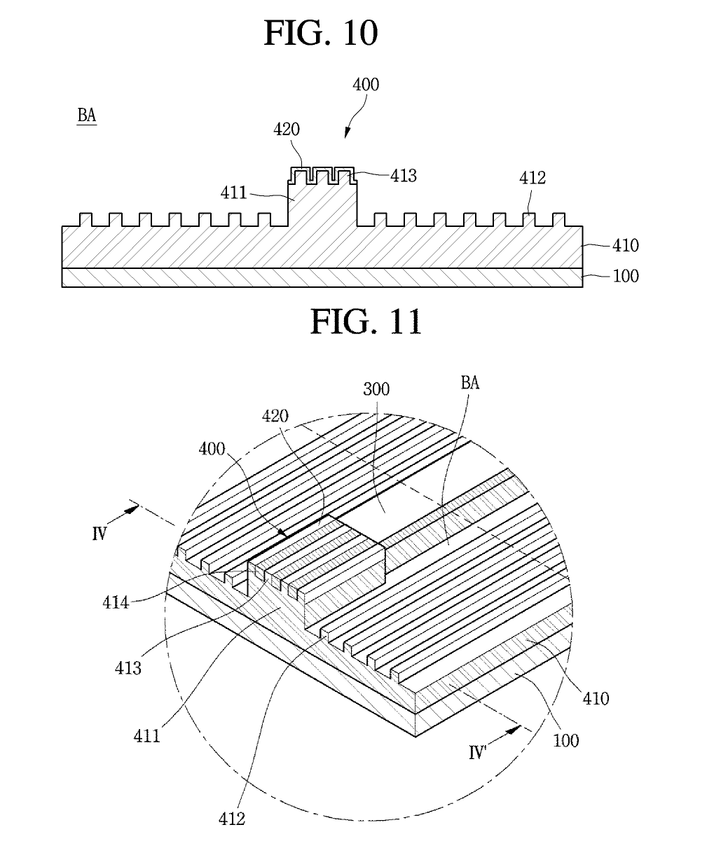

Meanwhile, referring to FIG. 10, the touch window according to another embodiment may include the third pattern 413 provided on the first pattern 411. The sectional surface of the third pattern 413 may have a rectangular shape. The third pattern 413 may be formed thereon with the conductive layer 420.

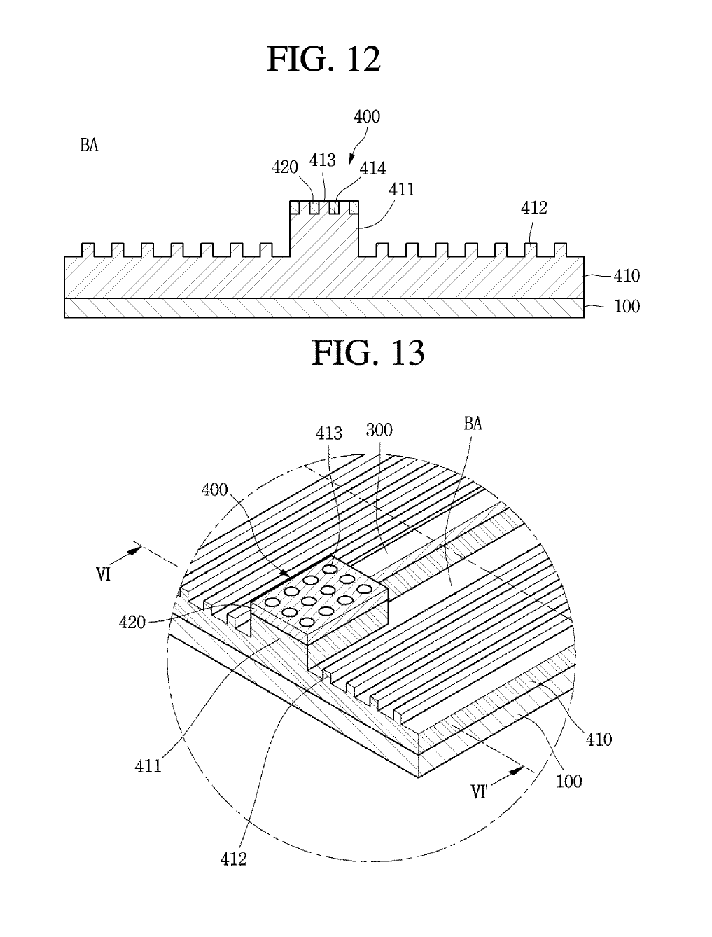

Meanwhile, referring to FIGS. 11 and 12, the touch window according to another embodiment may include the third pattern 413 on the first pattern 411, and the fourth pattern 414 adjacent to the third pattern 413. The third pattern 413 may be an embossed pattern, and the fourth pattern 414 may be an intaglio pattern.

In this case, the conductive layer 420 may be provided in the fourth pattern 414. In other words, the conductive layer 420 may be formed at parts other than the third pattern 413. Accordingly, when the pad part 400 is viewed from the top, the conductive layer 420 may be provided in a stripe shape.

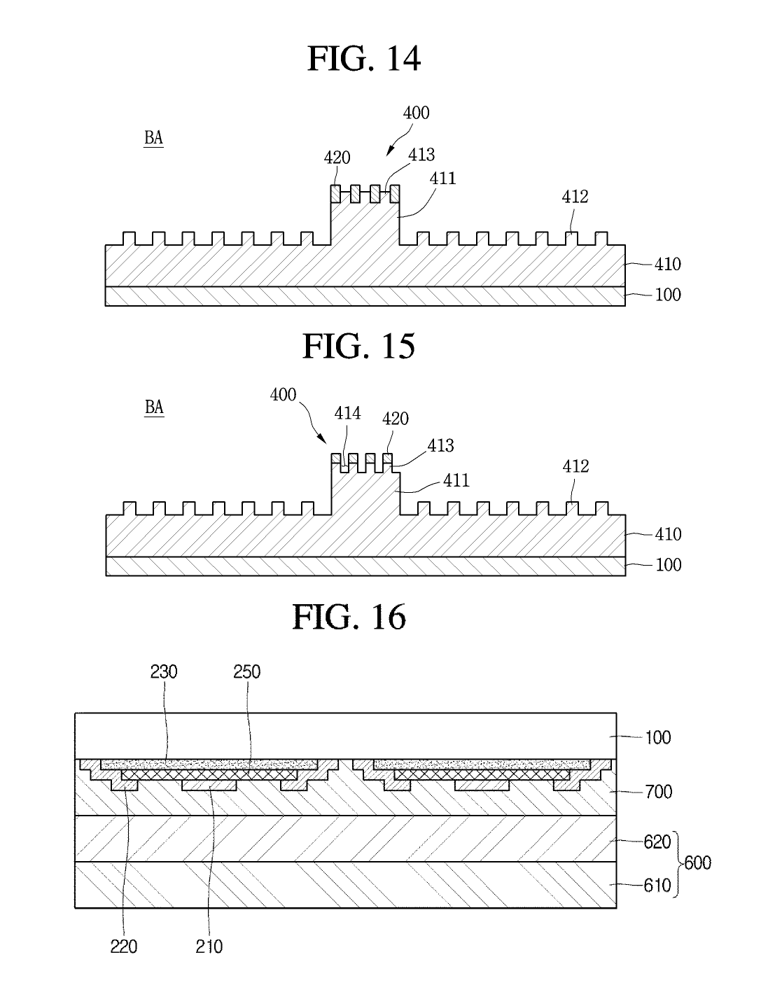

Meanwhile, referring to FIGS. 13 and 14, the touch window according to another embodiment may include the third pattern 413. When the third pattern 413 is viewed from the top, the third pattern 413 may have a circular shape. The third pattern 413 may be an embossed pattern. In this case, the conductive layer 420 may be formed at parts other than the third pattern 413. Meanwhile, as shown in FIG. 14, the height of the conductive layer 420 may be formed higher than the height of the third pattern 413.

Meanwhile, referring to FIG. 15, the touch window according to another embodiment may include the third pattern 413 having the embossed pattern and the fourth pattern 414 having the intaglio pattern, and the conductive layer 420 may be provided only the third pattern 413.

Hereinafter, a touch device in which the touch window described above is coupled to a display panel will be described with reference to FIGS. 16 to 19. In detail, referring to FIG. 16, the touch device may be formed by coupling the substrate 100 to a display panel 600. The substrate 100 may be bonded to the display panel 600 through an adhesive layer 700. For example, the substrate 100 may be coupled to the display panel 600 through the adhesive layer 700 including an optical clear adhesive (OCA).

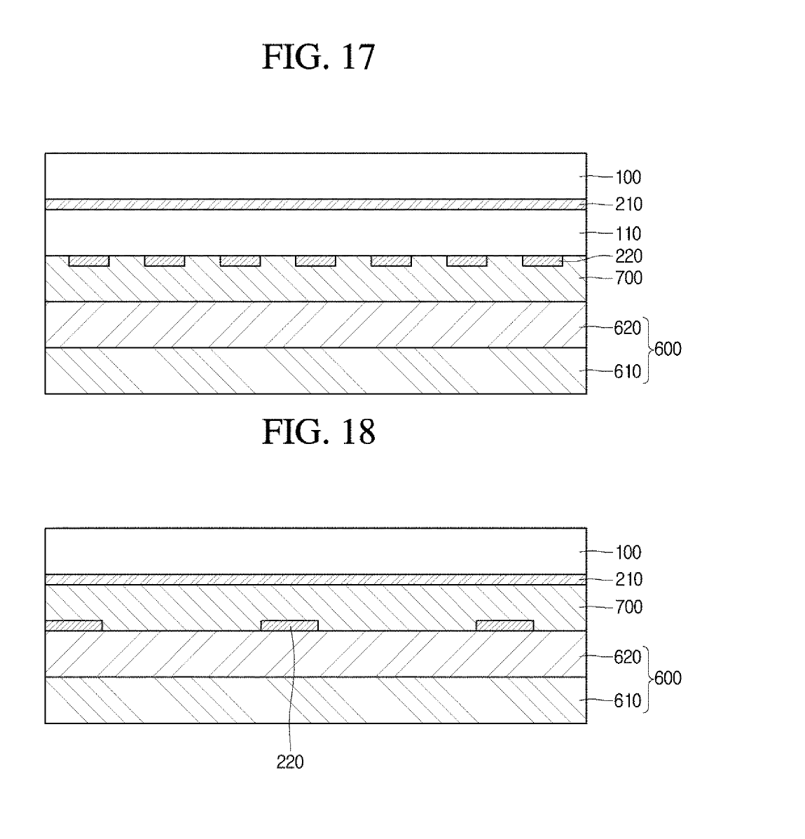

Referring to FIG. 17, when a second substrate 110 is additionally provided on the substrate 100, the touch device may be formed by coupling the substrate 100 to the display panel 600. The second substrate 110 may be bonded with the display panel 600 through the adhesive layer 700. For example, the first substrate 100 may be combined with the display panel 600 through the adhesive layer 700 including the OCA.

The display panel 600 may include first and second substrates 610 and 620.

When the display panel 600 is a liquid crystal display panel, the display panel 600 may be formed in a structure in which a first panel substrate 610 including a thin film transistor (TFT) and a pixel electrode is combined with a second panel substrate 620 including color filter layers while the first and second panel substrates 610 and 620 interpose a liquid crystal layer therebetween.

In addition, the display panel 600 may be a liquid crystal display panel having a COT (color filter on transistor) structure in which the second panel substrate 620 is combined with the first panel substrate 610 on which a thin film transistor, a color filter and a black matrix are formed while a liquid crystal layer is interposed between the first and second panel substrates 610 and 620. In other words, the thin film transistor is formed on the first panel substrate 610, the protective layer is formed on the thin film transistor, and the color filter layers are formed on the protective layer. In addition, the pixel electrode making contact with the thin film transistor is formed on the first panel substrate 610. In this case, in order to improve an aperture rate and simplify a mask process, the black matrix may be omitted and a common electrode may be formed to perform the inherent function thereof together with the function of the black matrix.

In addition, when the display panel 600 is a liquid crystal panel, the display device may further include a backlight unit for providing light from the rear surface of the display panel 600.

When the display panel 600 is an organic light emitting device, the display panel 600 includes a self light-emitting device which does not require any additional light source. In the display panel 600, a thin film transistor is formed on the first panel substrate 610 of the display panel 600, and an organic light emitting device (OLED) making contact with the thin film transistor is formed. The OLED may include an anode, a cathode and an organic light-emitting layer formed between the anode and the cathode. In addition, the second panel substrate 620 may be further formed on the organic light demitting device to perform the function of an encapsulation substrate for encapsulation.

Referring to FIG. 18, the touch device according to the embodiment may include a touch panel integrated with the touch panel 600. In other words, a substrate 100 to support at least one sensing electrode 200 may be omitted.

In detail, at least one sensing electrode 200 may be provided on at least one surface of the display panel 600. In other words, at least one sensing electrode 200 may be formed on at least one surface of the first panel substrate 610 or the second panel substrate 620.

In this case, at least one sensing electrode 200 may be formed on the top surface of the substrate 100 serving as an upper substrate.

In detail, referring to FIG. 18, a first sensing electrode 210 may be provided on one surface of the substrate 100. In addition, a first wire connected with the first sensing electrode 210 may be provided. In addition, a second sensing electrode 220 may be provided on one surface of the display panel 600. In addition, a second wire connected with the second sensing electrode 220 may be provided.

The adhesive layer 700 is interposed between the substrate 100 and the display panel 600, so that the substrate 100 can be combined with the display panel 600.

In addition, the polarizing plate may be provided under the substrate 100. The polarizing plate may be a linear polarizing plate or an anti-reflection polarizing plate. For example, when the display panel 600 is a liquid crystal display panel, the polarizing plate may be a linear polarizing plate. In addition, when the display panel 600 is an organic electroluminescent display panel, the polarizing plate may be an anti-reflection polarizing plate.

According to the touch device of the embodiment, at least one substrate 100 to support the sensing electrode 200 may be omitted. Accordingly, a thin and light touch device may be formed.

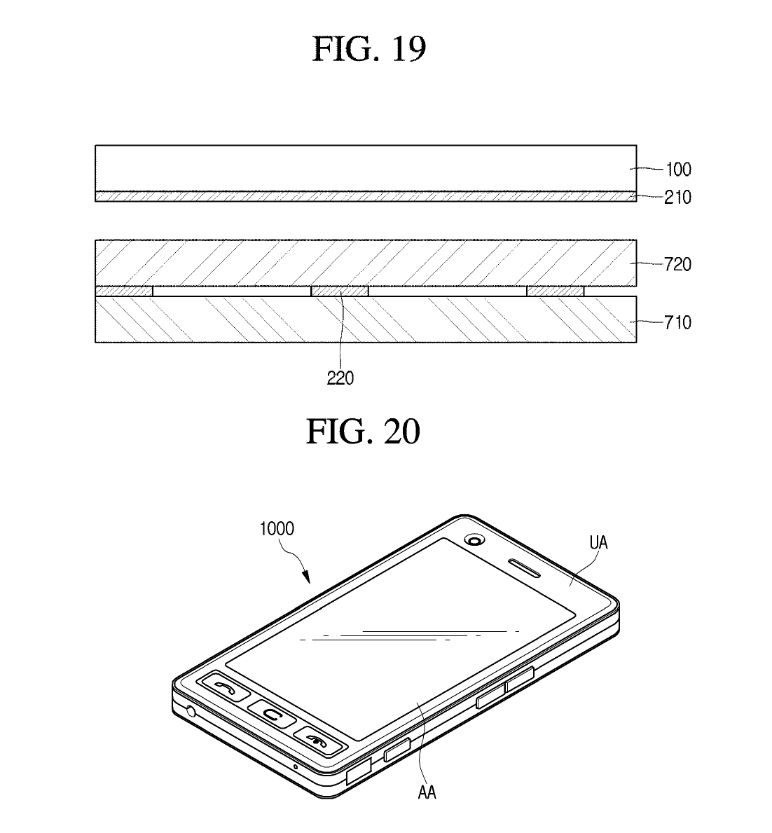

Meanwhile, a touch device according to another embodiment will be described with reference to FIG. 19. In the following description about the touch window according to another embodiment, the details of the structures and the components the same as or similar to those of the touch window according to the embodiment described above will be omitted.

Referring to FIG. 19, the touch device according to the embodiment may include a touch panel formed integrally with the display panel 600. In other words, a substrate 100 to support at least one sensing electrode 200 may be omitted.

A sensing electrode, which serves as a sensor disposed in an active region to sense a touch, and a wire to apply an electrical signal to the sensing electrode 200 may be formed inside the display panel. In detail, at least one sensing electrode 200 or at least one wire may be formed inside the display panel.

The display panel 600 includes first and second panel substrates 610 and 620. In this case, at least one of the first and second sensing electrodes 210 and 220 is disposed between the first and second panel substrates 610 and 620. That is, at least one sensing electrode 200 may be formed on at least one surface of the first or second substrate 610 or 620.

The first sensing electrode 210 may be provided on one surface of the substrate 100. In addition, the first wire connected with the first sensing electrode 210 may be provided. In addition, the second sensing electrode 220 and the second wire may be interposed between the first and second substrates 610 and 620. In other words, the second sensing electrode 220 and the second wire are provided inside the display panel, and the first sensing electrode 210 and the first wire may be provided outside the display panel.

The second sensing electrode 220 and the second wire may be provided on the top surface of the first substrate 610 or the rear surface of the second substrate 620.

A polarizing plate may be additionally provided under the substrate 100.

When the display panel is a liquid crystal display panel and the second sensing electrode 220 is formed on the top surface of the first panel substrate 610, the sensing electrode 200 may be formed together with a thin film transistor (TFT) or a pixel electrode. In addition, when the sensing electrode 220 is formed on the rear surface of the second substrate 620, a color filter layer may be formed on the sensing electrode 200 or the sensing electrode 200 may be formed on the color filter layer. When the display panel is an organic light emitting device and the second sensing electrode 220 is formed on the top surface of the first panel substrate 610, the second sensing electrode 220 may be formed together with a thin film transistor or an organic light emitting device.

According to the touch device of the embodiment, at least one substrate to support the sensing electrode 200 may be omitted. Accordingly, a thin and light touch device may be formed. In addition, the sensing electrode 200 and the wire are formed together with the device formed on the display panel, so that the process can be simplified and the cost can be saved.

Hereinafter, a display device employing the touch window according to the embodiment will be described with reference to FIGS. 20 to 23.

Referring to FIG. 20, a mobile terminal is shown as an example of a touch device. The mobile terminal may include an active region AA and an unactive region UA. In the active region AA, a touch signal generated due to the touch by a finger is sensed, and a command icon part and a logo may be formed in the unactive region UA.

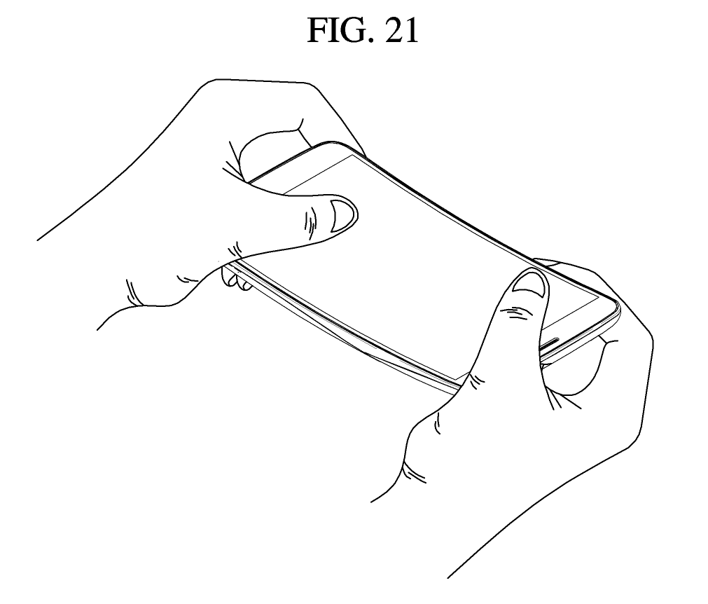

Referring to FIG. 21, a touch window may include a flexible touch window. Accordingly, the touch device including the flexible touch window may be a flexible touch device. Accordingly, a user may curve or bend the touch device with a hand. The flexible touch window may be applied to a wearable touch scheme.

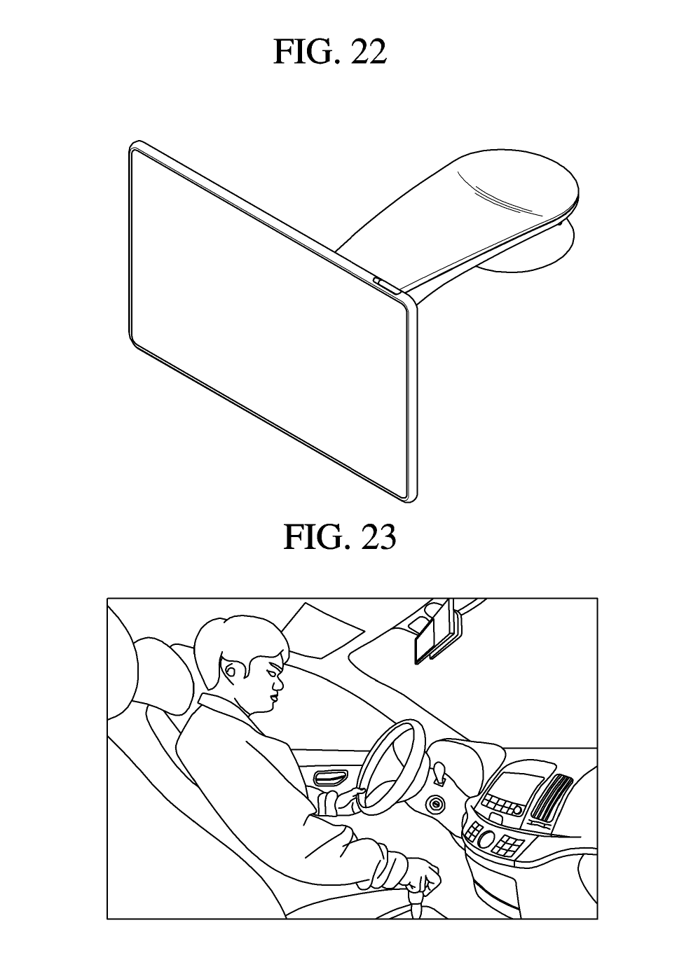

Referring to FIG. 22, the touch window may be applied to a vehicle navigation as well as the touch device such as the mobile terminal.

Referring to FIG. 23, the touch window may be applied into a vehicle. In other words, the touch window may be applied to various parts in the vehicle, which allow the application of the touch window. Accordingly, the touch window is applied to a dashboard as well as a PND (Personal Navigation Display), thereby realizing a CID (Center Information Display). However, the embodiment is not limited to the embodiment. In other words, the display may be used in various electronic products.

The embodiment provides a touch window having improved reliability and a touch device including the same.

According to the embodiment, there is provided a touch window including a substrate, a sensing electrode on the substrate, a wire electrically connected with the sensing electrode, and a pad part provided at one end of the wire and connected with a printed circuit board. The pad part has surface roughness different from surface roughness of the wire.

According to the embodiment, there is provided a touch device including a touch window, and a driving part on the touch widow. The touch window includes a substrate, a sensing electrode on the substrate, a wire electrically connected with the sensing electrode, and a pad part provided at one end of the wire and connected with a printed circuit board. The pad part has surface roughness different from surface roughness of the wire.

As described above, according to the embodiment, the contact area of the pad part of the wire with the printed circuit board can be increased. Accordingly, the bonding characteristic between the pad part and the printed circuit board can be improved. Accordingly, an input signal can be exactly transmitted to the printed circuit board, and the reliability of the touch window can be improved.

In addition, an additional bonding material may be omitted or reduced between the pad part and the printed circuit board. Accordingly, the process can be simplified, and the cost can be saved.

It will be understood that, when a layer (or film), a region, a pattern, or a structure is referred to as being “on” or “under” another substrate, another layer (or film), another region, another pad, or another pattern, it can be “directly” or “indirectly” on the other substrate, layer (or film), region, pad, or pattern, or one or more intervening layers may also be present. Such a position of the layer has been described with reference to the drawings

In the following description, when a part is connected to the other part, the parts are not only directly connected to each other, but also indirectly connected to each other while interposing another part therebetween. In addition, when a predetermined part “includes” a predetermined component, the predetermined part does not exclude other components, but may further include other components unless otherwise indicated.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A touch window comprising:
a substrate;
a sensing electrode on the substrate;
a wire electrically coupled with the sensing electrode; and
a pad provided at one end of the wire and coupled with a printed circuit board,
wherein the pad part has surface roughness (Ra) different from surface roughness (Ra) of the wire.

2. The touch window of claim 1, wherein the surface roughness (Ra) of the pad is greater than the surface roughness (Ra) of the wire.

3. The touch window of claim 1, wherein roughness (Ra) of a pad surface is greater than roughness (Ra) of a wire surface.

4. The touch window of claim 1, wherein a top surface of the wire has a pattern different from a pattern of a top surface of the pad.

5. The touch window of claim 1, wherein a top surface of the pad has a fine pattern.

6. The touch window of claim 1, wherein the substrate comprises a bonding pad bonded to the printed circuit board, and
wherein the bonding pad includes:
a first pattern;
a second pattern adjacent to the first pattern; and
a conductive layer on the first pattern.

7. The touch window of claim 6, further comprising a third pattern on the first pattern, wherein the third pattern has a line width wider than a line width of the second pattern.

8. The touch window of claim 7, wherein the line width of the third pattern is narrower than a line width of the pad part.

9. The touch window of claim 7, wherein the line width of the third pattern is narrower than ½ of a line width of the pad.

10. The touch window of claim 6, wherein the conductive layer comprises parts having heights different from each other.

11. The touch window of claim 7, wherein the conductive layer is provided on the third pattern.

12. The touch window of claim 6, wherein the conductive layer has a protrusion shape.

13. The touch window of claim 7, further comprising a fourth pattern having an intaglio pattern adjacent to the third pattern, wherein the conductive layer is provided in the fourth pattern.

14. A touch window comprising:
a substrate comprising an active region and an unactive region;
a sensing electrode on the active region;
a wire on the unactive region; and
a pad to electrically couple the wire with a printed circuit board,
wherein a top surface of the pad has an uneven shape.

15. The touch window of claim 14, wherein the unevenness shape of the top surface of the pad comprises at least two third patterns.

16. The touch window of claim 15, wherein the third patterns have a semi-circular shape.

17. The touch window of claim 15, wherein the third patterns have at least one of a triangular shape, a rectangular shape, and a polygonal shape.

18. The touch window of claim 15, wherein the uneven shape of the top surface of the pad further comprises at least two fourth patterns.

19. The touch window of claim 18, wherein the third patterns are embossed patterns, and the fourth patterns are intaglio patterns.

20. A touch device comprising:
a touch window; and
a driving component on the touch widow,
wherein a touch window includes:
a substrate;
a sensing electrode on the substrate;
a wire electrically coupled with the sensing electrode; and
a pad provided at one end of the wire and connected with a printed circuit board, and
wherein the pad has surface roughness(Ra) different from surface roughness(Ra) of the wire.
